(19) United States
(12) Patent Application Publication
(10) Pub. No.: US 2018/0086900 A1
(43) Pub. Date: Mar. 29, 2018

(54) PREPARATION OF SILICA REINFORCED RUBBER COMPOSITION, RUBBER COMPOSITION AND TIRE WITH COMPONENT

(71) Applicant: The Goodyear Tire & Rubber Company, Akron, OH (US)

(72) Inventors: George Jim Papakonstantopoulos, Medina, OH (US); Bruce Raymond Hahn, Hudson, OH (US)

(21) Appl. No.: 15/278,768

(22) Filed: Sep. 28, 2016

(51) Int. Cl. C08K 9/06; C08L 9/06

(52) U.S. Cl. CPC C08K 9/06; C08L 2205/06; C08L 2205/02; C08L 9/06

(57) ABSTRACT

The invention relates to preparation of a precipitated silica reinforced rubber composition, a resulting rubber composition and tire with component comprised of such rubber composition. The invention relates to blending a pre-formed composite of pre-hydrophobated precipitated silica and fatty acid with a rubber composition and subsequently reacting zinc oxide therewith in situ within the rubber composition to form a zinc salt of such fatty acid of said composite. The invention further relates to promoting said reaction of said zinc oxide and said fatty acid of said composite in situ within the rubber composition in the presence of an oligomer of 1,2-dihydro-2,2,4 trimethylquinoline. The invention additionally relates to a rubber composition thereof and tires with component of such rubber compositions such as a tire tread.

### FIELD OF THE INVENTION

The invention relates to preparation of a precipitated silica reinforced rubber composition, a resulting rubber composition and tire with component comprised of such rubber composition. The invention relates to blending a pre-formed composite of pre-hydrophobated precipitated silica and fatty acid with a rubber composition and subsequently reacting zinc oxide therewith in situ within the rubber composition to form a zinc salt of such fatty acid of said composite. The invention further relates to promoting said reaction of said zinc oxide and said fatty acid of said composite in situ within the rubber composition in the presence of an oligomer of 1,2-dihydro-2,2,4 trimethylquinoline. The invention additionally relates to a rubber composition thereof and tires with component of such rubber compositions such as a tire tread.

### BACKGROUND OF THE INVENTION

Tires may be prepared with a component comprised of a rubber composition component which contains filler reinforcement comprised of precipitated silica.

In one embodiment, such precipitated silica may be provided as a pre-hydrophobated precipitated silica to convert the precipitated silica from a hydrophobic state to a hydrophilic state and to thereby promote its dispersibility in a rubber composition containing a diene based elastomer.

In a further embodiment, such pre-hydrophobated precipitated may be provided as a composite thereof with a fatty acid as a processing aid to further promote its compatibility with a rubber composition containing a diene based elastomer.

The precipitated silica may be pre-hydrophobated by treating the precipitated silica with a silica coupling agent comprised of at least one of bis(3-trialkoxysilylpropyl) polysulfide and alkoxyorganomercaptosilane prior to its introduction into the rubber composition.

However, such composite of pre-hydrophobated precipitated silica and fatty acid is contemplated as retarding a rate of reactive coupling of the precipitated silica to an associated diene-based elastomer and to thereby retard a rate of reinforcement of a rubber composition containing the diene-based elastomer.

Therefore, a challenge is presented for promoting a more efficient reactive coupling of a diene-based elastomer with a pre-hydrophobated precipitated silica/fatty acid composite and particularly an acceleration of such reactive coupling.

In the description of this invention, the term “phr” relates to parts by weight for a material or ingredient per 100 parts by weight elastomer(s)”. The terms “rubber” and “elastomer” are used interchangeably unless otherwise indicated. The terms “cure” and “vulcanize” are used interchangeably unless otherwise indicated.

### SUMMARY AND PRACTICE OF THE INVENTION

In accordance with this invention a method is provided which comprises:

(A) forming a dispersion of hydrophobated precipitated silica in a rubber composition containing at least one diene-based elastomer by steps of:
(1) blending a pre-hydrophobated precipitated silica/fatty acid composite (referred to herein as a composite) with a rubber composition containing at least one diene-based elastomer to form a dispersion of said composite in said rubber composition,
(2) blending zinc oxide with said rubber composition containing said composite dispersion,
(3) reacting said zinc oxide with said fatty acid of said composite in said rubber composition to thereby substantially convert said fatty acid of said composite to a zinc salt thereof in situ within the rubber composition and to thereby substantially remove said fatty acid from said composite to yield a substantially fatty acid-free hydrophobated precipitated silica within said rubber composition, and/or substantially displacing said fatty acid of said composite of pre-hydrophobated precipitated silica directly without reacting with said fatty acid and to thereby expose thiol or polysulfide groups of the composite to aid in coupling the composite to at least one diene-based elastomer in said rubber composition;

(B) coupling said substantially fatty acid-free hydrophobated precipitated silica to said diene-based elastomer(s) in situ within said rubber composition;

wherein said pre-hydrophobated precipitated silica is a product of reacting a precipitated silica (hydrophilic precipitated silica) with silica coupling agent comprised of at least one of bis(3-trialkoxysilylpropyl) polysulfide and alkoxyorganomercaptosilane, particularly an alkoxyorganomercaptosilane,

wherein said fatty acid of said composite is comprised of at least one of stearic, palmitic, oleic and linoleic acid.

In one embodiment, said method comprises reacting said zinc oxide with said fatty acid of said composite in situ within said rubber composition in the presence of an oligomer of 1,2-dihydro-2,2,4 trimethylquinoline.

In one embodiment, said zinc oxide substantially displaces said fatty acid of said composite of pre-hydrophobated precipitated silica directly without reacting with said fatty acid and to thereby expose thiol or polysulfide groups of the composite to aid in coupling the composite to at least one diene-based elastomer in said rubber composition.

In one embodiment, said zinc oxide is added together with said composite to said rubber composition.

In one embodiment, said zinc oxide is added to said rubber composition subsequent to addition of said composite to said rubber composition.

In one embodiment, said zinc oxide is added to said rubber composition in the absence of freely added fatty acid (in the absence of fatty acid added to the rubber composition other than the fatty acid of said composite).

In one embodiment, said zinc oxide reacts with said fatty acid of said composite to form a zinc/fatty ester (e.g. zinc stearate, palmitate, and/or oleate) to thereby beneficially substantially remove the fatty acid from said composite and thereby expose thiol or polysulfide groups of the composite to aid in coupling the composite to at least one diene-based elastomer in said rubber composition.

In one embodiment, said coupling of the exposed thiol or polysulfide groups to at least one diene-based elastomer in said rubber composition happens in the presence of an oligomer of 1,2-dihydro-2,2,4 trimethylquinoline to thereby accelerate said coupling reaction.

In one embodiment a silica coupler may be additionally added to said rubber composition. Representative of such silica coupler is, for example, a bis(3-triethoxysilylpropyl) polysulfide containing an average of from 2 to 4 connecting sulfur atoms in its polysulfidic bridge and an alkoxyorganomercaptosilane.

In one embodiment, a precipitated silica (non-pre-hydrophobated precipitated silica) may be added to the rubber composition.

In further accordance with this invention, a rubber composition is provided by said method.

In additional accordance with this invention a tire is provided having a component comprised of such rubber composition.

Representative of various said organomercaptosilanes are, for example and not intended to be limiting, triethoxy mercaptopropyl silane, trimethoxy mercaptopropyl silane, methyl dimethoxy mercaptopropyl silane, methyl diethoxy mercaptopropyl silane, dimethyl methoxy mercaptopropyl silane, triethoxy mercaptoethyl silane, and tripropoxy mercaptopropyl silane.

In further accordance with this invention, a tire of this invention is provided where said component thereof may be, for example, a tire tread such as, for example, a tread, tread cap and/or tread base, tire sidewall, tire carcass component such as, for example, a carcass cord ply coat, tire sidewall stiffening insert, an apex adjacent to or spaced apart from a tire bead, tire chafer and tire bead component.

Significantly, by the practice of this invention, an addition of a coupling agent to the rubber composition for an in-situ interaction is not considered herein as being necessary, although optional, for the hydrophobated silica to effectively reinforce the rubber composition because the pre-hydrophobated precipitated silica contains an integral coupling agent, namely, the at least one bis(3-ethoxysilylpropyl) polysulfide or alkoxyorganomercaptosilane treated precipitated silica of said composite.

However as previously indicated, if desired, a coupling agent may be added to the rubber composition to further hydrophobate the precipitated silica in situ within the rubber composition

In the practice of this invention, the various components of the tire may be a rubber composition comprised of various conjugated diene based elastomers. Such diene-based elastomers may be polymers and copolymers of conjugated dienes, such as, for example, isoprene and 1,3-butadiene, and copolymers of at least one conjugated diene hydrocarbon and vinyl aromatic compound selected from styrene and alphamethyl styrene, preferably styrene.

For example, representative of such elastomers are cis 1,4-polyisoprene rubber (natural and synthetic), cis 1,4-polybutadiene rubber, high vinyl polybutadiene rubber having a vinyl 1,2 content in a range of about 10 percent to about 90 percent, styrene/butadiene copolymer (SBR) rubber (aqueous emulsion or organic solution polymerization prepared copolymers) and including organic solvent polymerization prepared SBR having a vinyl 1,2-content in a range of about 10 to about 90 percent based on its polybutadiene derived portion and a polystyrene content in a range of about 10 to about 60 percent based upon the copolymer, styrene/isoprene/butadiene terpolymer rubber, butadiene/acrylonitrile rubber, styrene/isoprene copolymer and isoprene/butadiene copolymer rubber, 3,4-polyisoprene rubber and trans 1,4-polybutadiene rubber.

Organic solvent polymerization prepared tin or silicon coupled elastomers such as for example, tin or silicon coupled styrene/butadiene copolymers, may also be used.

Tin or silicon coupled copolymers of styrene/butadiene may be prepared, for example, by introducing a tin or silicon coupling agent during the styrene/1,3-butadiene monomer copolymerization reaction in an organic solvent solution, usually at or near the end of the polymerization reaction. Such coupling of styrene/butadiene copolymers is well known to those having skill in such art.

In practice, it is usually preferred that at least 50 percent, and more generally in a range of about 60 to about 85 percent, of the Sn (tin) bonds in the tin coupled elastomers are bonded to butadiene units of the styrene/butadiene copolymer to create Sn-dienyl bonds such as butadienyl bonds.

Creation of tin-dienyl bonds can be accomplished in a number of ways such as, for example, sequential addition of butadiene to the copolymerization system or use of modifiers to alter the styrene and/or butadiene reactivity ratios for the copolymerization. It is believed that such techniques, whether used with a batch or a continuous copolymerization system, is well known to those having skill in such art.

Various tin compounds, particularly organo tin compounds, may be used for the coupling of the elastomer. Representative of such compounds are, for example, alkyl tin trichloride, dialkyl tin dichloride, yielding variants of a tin coupled styrene/butadiene copolymer elastomer, although a trialkyl tin monochloride might be used which would yield simply a tin-terminated copolymer.

Examples of tin-modified, or coupled, styrene/butadiene copolymer elastomers might be found, for example, in U.S. Pat. No. 5,064,901.

As previously indicated, various commercially available precipitated silicas may also be added to the rubber composition together with the said pre-hydrophobated silica for the reinforcement of the diene based elastomers. Such precipitated silica may typically be characterized by their BET surface areas. Representative of such silicas, for example, only and without limitation, are silicas available from PPG Industries under the Hi-Sil trademark with designations 210, 243, etc., silicas available from Solvay with designations of Zeosil 1165MP and Zeosil 165GR, silicas available from Evonik with designations VN2 and VN3 and silicas available from Huber as Zeopol 8745 and Zeopol 8715.

It is readily understood by those having skill in the art that the rubber composition of the tread rubber would be compounded by methods generally known in the rubber compounding art, such as mixing the various sulfur-vulcanizable constituent rubbers with various commonly used additive materials such as, for example, curing aids, such as sulfur, activators, retarders and accelerators, processing additives, such as oils, resins including tackifying resins and plasticizers, fillers, pigments, fatty acid, zinc oxide, waxes, antioxidants and antiozonants, peptizing agents and reinforcing materials such as, for example, carbon black. As known to those skilled in the art, depending on the intended use of the sulfur vulcanizable and sulfur vulcanized material (rubbers), the additives mentioned above are selected and commonly used in conventional amounts.

The presence and relative amounts of the above additives are not considered to be an aspect of the present invention unless otherwise indicated.

The tires can be built, shaped, molded and cured by various methods which will be readily apparent to those having skill in such art.

### EXAMPLE I

Rubber compositions were prepared to evaluate preparation of precipitated silica reinforced rubber composition by blending a pre-formed composite of pre-hydrophobated precipitated silica and fatty acid with a rubber composition and subsequently reacting zinc oxide therewith in situ within the rubber composition to form a zinc salt of such fatty acid of said composite, in the absence of freely added fatty acid.

Rubber compositions were further prepared to evaluate reaction of said zinc oxide and said fatty acid of said composite in situ within the rubber composition in the presence of an oligomer of 1,2-dihydro-2,2,4 trimethylquinoline.

The basic formulation for the evaluation is illustrated in the following Table 1 which is presented in terms of parts per 100 parts by weight of rubber (phr).

For this evaluation, rubber compositions are prepared by mixing the elastomers(s) without sulfur and sulfur cure accelerators in a non-productive mixing stage (NP) in an internal rubber mixer for about 3 to 6 minutes to a temperature of about 155 to about 170° C.

The resulting mixture was not further mixed in a productive mixing stage (PR) in an internal rubber mixer with sulfur and sulfur cure accelerator(s) in order to evaluate the effect of the zinc oxide and of the oligomer of 1,2-dihydro-2,2,4 trimethylquinoline.

TABLE 1
General Formulation

| Non-Productive Mixing Step (NP) | Parts (phr) |
|---|---|
| Styrene/butadiene rubber (SBR)¹ | 100 |
| Composite of pre-hydrophobated precipitated | 50 |
| silica and fatty acid² | |
| 1,2-dihydro-2,2,4 trimethylquinoline (TMQ)³ | 0, 2 |
| Zinc oxide | 0.5, 1, 2, 4 |

¹Styrene/butadiene rubber as Solflex ™ 16542 from The Goodyear Tire & Rubber Company having a Tg of about −42° C. and a bound styrene content of about 16 percent
²Composite of precipitated silica hydrophobated with alkoxyorganomercaptosilane, and containing fatty acid, as Agilon 400 ™ from PPG Industries
³TMQ, an oligomer of 1,2-dihydro-2,2,4 trimethylquinoline from Lanxess.

The following Table 2 represents the uncured and cure behavior and various physical properties of the rubber compositions based upon the basic formulation of Table 1, and reported as rubber Samples C1 through C5. Test samples were cured for 30 minutes at 160° C.

TABLE 2

| | Samples | | | | |
|---|---|---|---|---|---|
| | C1 | C2 | C3 | C4 | C5 |
| Styrene/butadiene rubber composite | 100 | 100 | 100 | 100 | 100 |
| Pre-hydrophobated precipitated silica | 50 | 50 | 50 | 50 | 50 |
| & fatty acid | | | | | |
| TMQ | 2 | 2 | 2 | 2 | 0 |
| Zinc oxide | 0.5 | 1 | 2 | 4 | 4 |

Properties
RPA test (Rubber Process Analyzer), Storage Modulus (G′) kPa

| | | | | | |
|---|---|---|---|---|---|
| Uncured G′, 15% strain 0.83 Hertz, | 436 | 459 | 458 | 475 | 545 |
| 100° C. | | | | | |
| Cured G′, 10% strain, 1 Hertz, | 514 | 576 | 580 | 633 | 583 |
| 100° C., kPa | | | | | |
| Tan delta, 10% strain, 1 Hertz, | 0.43 | 0.38 | 0.38 | 0.34 | 0.44 |
| 100° C. | | | | | |

It can be seen from Table 2 that progressively increasing an addition of from 0.5 to 4 parts of the zinc oxide, in the presence of the 1,2-dihydro-2,2,4 trimethylquinoline (the TMQ), progressively increased the cured G′ value of the rubber Samples C1 through C4 from a value of 514 to a value of 633 kPa which is an indication of increasing the cured stiffness of the rubber compositions.

It can further be seen from Table 2 that progressively increasing an addition of from 0.5 to 4 parts of the zinc oxide, in the presence of the oligomer of 1,2-dihydro-2,2,4 trimethylquinoline (the TMQ), decreased the tan delta value of the rubber Samples C1 through C4 from a value of 0.43 to a value of 0.34 which is an indication of a beneficial decrease in hysteresis of the rubber compositions.

However, the cured G′ value was significantly decreased to a value of 583 kPa when the TMQ was not used in rubber Sample C5 when compared to rubber Sample C4 with a G′ value of 633 which contained the TMQ, and where both of the rubber Samples C4 and C5 contained 4 parts of the zinc oxide.

However, the tan delta value was significantly increased to a value of 0.44 when the TMQ was not used in rubber Sample C5 when compared to rubber Sample C4 with a tan delta of 0.34 which contained the TMQ, and where both of the rubber Samples C4 and C5 contained 4 parts of the zinc oxide.

Therefore it is concluded that while the added zinc oxide beneficially reacts with the fatty acid contained in the composite of pre-hydrophobated precipitated silica to thereby displace some of the fatty acid from the precipitated silica surface of the composite, it has been discovered that a combination of the zinc oxide and the TMQ acts in a synergistic manner to enhance the reaction between the elastomer and the pre-hydrophobated precipitated silica surface.

It is concluded that TMQ combined with the added zinc oxide synergistically promoted an increased polymer-filler interaction of the composite of pre-hydrophobated precipitated silica and fatty acid to result in a beneficial increased cured stiffness (increased cured G′) and beneficial decreased hysteresis (reduced tan delta) of the rubber composition which are predictive of beneficial improvement in reduction of rolling resistance and increase in dry handling stiffness for a tire with tread of such rubber composition.

### EXAMPLE II

Rubber compositions were prepared to evaluate preparation of precipitated silica reinforced rubber composition by blending a pre-formed composite of pre-hydrophobated precipitated silica and fatty acid with a rubber composition and subsequently reacting zinc oxide therewith in situ within the rubber composition to form a zinc salt of such fatty acid of said composite, in the absence of freely added fatty acid.

Rubber compositions were further prepared to evaluate promoting said reaction of said zinc oxide and said fatty acid of said composite in situ within the rubber composition in the presence of an oligomer of 1,2-dihydro-2,2,4 trimethylquinoline (TMQ).

The basic formulation for the evaluation is illustrated in the following Table 3 which is presented in terms of parts per 100 parts by weight of rubber (phr).

For this evaluation, rubber compositions are prepared by mixing the elastomers(s) without sulfur and sulfur cure accelerators in a first non-productive mixing stage (NP-1) in an internal rubber mixer for about 3 to 5 minutes to a temperature of about 150 to about 170° C. The rubber mixture is then mixed in a second non-productive mixing stage (NP-2) in an internal rubber mixer for about 3 to about 5 minutes to a temperature of about 150 to about 170° C. with the addition of the rest of the ingredients for the non-productive part of the mixes. The resulting rubber mixture is then mixed in a productive mixing stage (PR) in an internal rubber mixer with sulfur and sulfur cure accelerator(s) for about 2 to about 4 minutes to a temperature of about 95 to about 110° C. The rubber composition may be sheeted out and cooled to below 50° C. between each of the non-productive mixing steps and prior to the productive mixing step. Such rubber mixing procedure is well known to those having skill in such art.

TABLE 3
General Formulation

| | Parts |
|---|---|
| First Non-Productive Mixing Step (NP1) | |
| Styrene/butadiene rubber (SBR)¹ | 60 |
| Cis 1,4-Polybutadiene rubber² | 40 |
| Composite of pre-hydrophobated precipitated | 50 |
| silica and fatty acid³ | |
| Fatty acid⁴ | 2 |
| Resin⁵ | 5.5 |
| Zinc stearate | 4 |
| Rubber processing oil | 11 |
| TMQ⁷ | 0, 1 |
| Zinc oxide | 0, 5 |
| Second Non-Productive Mixing Step (NP2) | |
| Carbon black⁶ | 2 |
| Composite of pre-hydrophobated precipitated | 40 |
| silica and fatty acid³ | |
| Resin⁵ | 12.5 |
| Antidegradant | 3.5 |
| Rubber processing oil | 4 |
| TMQ⁷ | 0, 1 |
| Zinc oxide | 0, 5 |
| Productive Mixing Step (PR) | |
| Zinc oxide | 0, 1.75 |
| Antidegradant | 0.75 |
| Sulfur | 1.6 |
| Sulfur vulcanization accelerators⁸ | 3 |

¹Styrene/butadiene rubber having a Tg of about −22° C. and a bound styrene content of about 20 percent
²Cis 1,4-polybutadiene rubber as Budene ™ 1223 from The Goodyear Tire & Rubber Company
³Composite of precipitated silica hydrophobated with alkoxyorganomercaptosilane, and containing fatty acid, as Agilon 400 ™ from PPG Industries
⁴Fatty acid comprised of stearic, palmitic and oleic acids
⁵Styrene-alphamethylstyrene resin
⁶Carbon black as N330, an ASTM designation
⁷TMQ, an oligomer of 1,2-dihydro-2,2,4 trimethylquinoline
⁸Sulfenamide and diphenylguanidine

The following Table 4 represents the uncured and cure behavior and various physical properties of the rubber compositions based upon the basic formulation of Table 1, and reported as rubber Samples D1 through D3. Test samples were cured for 30 minutes at 150° C.

TABLE 4

| | Samples | | |
|---|---|---|---|
| | D1 | D2 | D3 |
| NP1 Mixing Step | | | |
| Styrene/butadiene rubber | 60 | 60 | 60 |
| Cis 1,4-polybutdiene rubber | 40 | 40 | 40 |
| Composite: pre-hydrophobated precipitated | 50 | 50 | 50 |
| silica & fatty acid | | | |
| TMQ | 0 | 1 | 0 |
| Zinc oxide | 0 | 5 | 0 |
| NP2 Mixing Step | | | |
| Composite: pre-hydrophobated precipitated | 40 | 40 | 40 |
| silica & fatty acid | | | |
| TMQ | 1 | 0 | 0 |
| Zinc oxide | 5 | 0 | 0 |
| Productive Mixing Step | | | |
| Zinc Oxide | 0 | 0 | 2 |

Properties

| | | | |
|---|---|---|---|
| RPA test (Rubber Process Analyzer), Storage | | | |
| Modulus (G′) kPa | | | |
| Uncured G′, 15% strain 0.83 Hertz, 100° C. | 246 | 315 | 311 |
| Cured G′, 10% strain, 1 Hertz, 100° C., kPa | 1075 | 1118 | 1316 |
| Tan Delta, 10% strain, 1 Hertz, 100° C. | 0.05 | 0.1 | 0.07 |
| Stress-strain | | | |
| Elongation at break (%) | 435 | 524 | 417 |
| 300% modulus, (MPa) | 9.4 | 8.5 | 11.2 |
| Rebound | | | |
| Room Temperature (23° C.) | 45 | 41 | 38 |
| 100° C. | 77 | 64 | 71 |

It can be seen from Table 4 that the addition of zinc oxide in the non-productive stages for rubber Samples D1 and D2, and especially for the preparation of rubber Sample D1 where the zinc oxide was added after all of the composite of pre-hydrophobated precipitated silica and fatty acid had been added, can have a beneficial effect on the compound viscoelastic properties as indicated by a lower tan delta physical property (at 10% strain, 100° C., 1 Hertz) which, in turn, is predictive of a beneficial reduction in hysteresis for the rubber composition and beneficial lower rolling resistance for a tire with a tread of such rubber composition.

This option is the one that will allow for the highest probability of the aforementioned reactions to take place and increase the polymer filler interaction. Sample D1 exhibits the best indicated performance with respect to rolling resistance demonstrating the lowest hysteresis values (lowest tan delta value and the highest rebound values).

Therefore, it is concluded that addition of zinc oxide together with the TMQ in a non-productive mixing stage after addition of pre-hydrophobated silica allows for a synergistic interaction of the combination of zinc oxide and TMQ with the pre-hydrophobated silica/fatty acid composite which resulted in an increase in polymer-filler interaction as evidenced by improved hysteresis properties (increased rebound properties and decreased tan delta property) of the rubber composition of rubber Sample D1.

While certain representative embodiments and details have been shown for the purpose of illustrating the invention, it will be apparent to those skilled in this art that various changes and modifications may be made therein without departing from the spirit or scope of the invention.

What is claimed is:

1. A method is provided which comprises:
(A) forming a dispersion of hydrophobated precipitated silica in a rubber composition containing at least one diene-based elastomer by steps of:
(1) blending a pre-hydrophobated precipitated silica/fatty acid composite (referred to herein as a composite) with a rubber composition containing at least one diene-based elastomer to form a dispersion of said composite in said rubber composition,
(2) blending zinc oxide with said rubber composition containing said composite dispersion,
(3) reacting said zinc oxide with said fatty acid of said composite in said rubber composition to thereby substantially convert said fatty acid of said composite to a zinc salt thereof in situ within the rubber composition and to thereby substantially remove said fatty acid from said composite to yield a substantially fatty acid-free hydrophobated precipitated silica within said rubber composition, and/or substantially displacing said fatty acid of said composite of pre-hydrophobated precipitated silica directly without reacting with said fatty acid and to thereby expose thiol or polysulfide groups of the composite to aid in coupling the composite to at least one diene-based elastomer in said rubber composition;
(B) coupling said substantially fatty acid-free hydrophobated precipitated silica to said diene-based elastomer(s) in situ within said rubber composition;
wherein said pre-hydrophobated precipitated silica is a product of reacting a precipitated silica (hydrophilic precipitated silica) with silica coupling agent comprised of at least one of bis(3-trialkoxysilylpropyl) polysulfide and alkoxyorganomercaptosilane, particularly an alkoxyorganomercaptosilane,
wherein said fatty acid of said composite is comprised of at least one of stearic, palmitic, oleic and linoleic acid.

2. The method of claim 1 wherein said method comprises reacting said zinc oxide with said fatty acid of said composite in situ within said rubber composition in the presence of an oligomer of 1,2-dihydro-2,2,4 trimethylquinoline to thereby accelerate said coupling of said substantially fatty acid-free hydrophobated precipitated silica to said diene-based elastomer(s) within the rubber composition.

3. The method of claim 1 wherein said method comprises adding said zinc oxide together with said composite to said rubber composition.

4. The method of claim 1 wherein said method comprises adding said zinc oxide to said rubber composition subsequent to addition of said composite to said rubber composition.

5. The method of claim 1 wherein said zinc oxide is added to said rubber composition in the absence of freely added fatty acid.

6. The method of claim 1 wherein said zinc oxide reacts with said fatty acid of said composite to form a zinc/fatty ester to thereby beneficially substantially remove the fatty acid from said composite and thereby expose thiol or polysulfide groups of the composite to aid in coupling the composite to at least one diene-based elastomer in said rubber composition.

7. The method of claim 1 wherein a silica coupler may is additionally added to said rubber composition,

8. The method of claim 7 wherein said silica coupler is comprised of a bis(3-triethoxysilylpropyl) polysulfide containing an average of from 2 to 4 connecting sulfur atoms in its polysulfidic bridge or an alkoxyorganomercaptosilane.

9. The method of claim 1 wherein said organomercaptosilane is comprised of at least one of triethoxy mercaptopropyl silane, trimethoxy mercaptopropyl silane, methyl dimethoxy mercaptopropyl silane, methyl diethoxy mercaptopropyl silane, dimethyl methoxy mercaptopropyl silane, triethoxy mercaptoethyl silane, and tripropoxy mercaptopropyl silane.

10. The method of claim 1 wherein said zinc oxide substantially displaces said fatty acid of said composite of pre-hydrophobated precipitated silica directly without reacting with said fatty acid and to thereby expose thiol or polysulfide groups of the composite to aid in coupling the composite to at least one diene-based elastomer of said rubber composition.

11. A rubber composition prepared by the method of claim 1.

12. A rubber composition prepared by the method of claim 2.

13. A rubber composition prepared by the method of claim 3.

14. A rubber composition prepared by the method of claim 4

15. A rubber composition prepared by the method of claim 5.

16. A rubber composition prepared by the method of claim 10.

17. A tire having a component comprised of the rubber composition of claim 11.

18. A tire having a component comprised of the rubber component of claim 12.

19. A tire having a component comprised of the rubber composition of claim 15.

20. A tire having a component comprised of the rubber component of claim 16.
